(19) United States
(12) Patent Application Publication
(10) Pub. No.: US 2026/0253231 A1
(43) Pub. Date: Aug. 27, 2026

(54) APPARATUS AND METHOD FOR SEGMENTATION OF OBJECT IN VISUAL MEDIA

(71) Applicant: RESEARCH & BUSINESS FOUNDATION SUNGKYUNKWAN UNIVERSITY, Suwon-si (KR)

(72) Inventors: Sung Eun HONG, Seoul (KR); Ji Yun KIM, Incheon (KR); Joo Ho KIM, Seoul (KR)

(21) Appl. No.: 19/545,267

(22) Filed: Feb. 20, 2026

(30) Foreign Application Priority Data
Feb. 26, 2025 (KR) 10-2025-0025322

(51) Int. Cl. G06T 7/12; G06N 3/0464; G06N 3/048; G06V 10/74; G06V 10/80

(52) U.S. Cl. CPC G06T 7/12; G06N 3/0464; G06N 3/048; G06V 10/761; G06V 10/806

(57) ABSTRACT

An apparatus and method for segmentation of an object in visual media are provided. The apparatus comprises a storage storing at least one of a query memory layer, a key memory layer, and a value memory layer, and a processor configured to obtain a value feature by encoding a segmentation target visual media and a mask, generate at least one parent group based on the value feature, apply the query memory layer to the at least one parent group, apply the key memory layer to a concatenation result of the at least one parent group to which the query memory layer is applied, obtain an attention map from an application result of the key memory layer, apply the value memory layer to the attention map, and obtain a refined feature by combining an application result of the value memory layer and the value feature.

### CROSS-REFERENCE TO RELATED APPLICATION

This application claims the priority benefit of Korean Patent Application No. 10-2025-0025322 filed on Feb. 26, 2025 in the Korean Intellectual Property Office, the disclosures of which are incorporated herein by reference.

### BACKGROUND

### 1. Field

The present invention relates to an apparatus for segmentation of an object in visual media and a method for segmentation of an object in visual media.

### 2. Description of the Related Art

The VOS (Video Object Segmentation) technology is a technology for identifying a specific object in a video or a still image at a pixel level and tracking the identified object as needed, and since important information may be extracted from complex visual data, its use is gradually increasing in various fields such as autonomous driving and medical image analysis.

Such video object segmentation may also be viewed as a pixel-by-pixel classification problem. A SVOS (Semi-supervised Video Object Segmentation) technique is one of the video object segmentation techniques, and is a technique for detecting and segmenting a corresponding object in each image frame throughout a video by using information on an object when the information is provided for some frames of the video. Semi-supervised video object segmentation is particularly suitable in situations where consistent and accurate object tracking is required, such as monitoring or video editing, by effectively combining the high accuracy of the fully supervised learning approach and the autonomy of the unsupervised approach. In addition, since semi-supervised object segmentation is implemented using only a single ground-truth annotation, there is an advantage in that fairly effective object segmentation results can be obtained while reducing the computational time required for learning and input resources.

However, most semi-supervised video object segmentation methods use 2D convolutional neural networks (2D CNNs) as an encoder, which makes it difficult to efficiently capture temporal information, thereby revealing limitations in processing data having temporal variations, such as videos. In other words, conventional convolutional neural network-based models may fail to consider both intra-frame relationships and temporal dependencies between video frames. This limitation also applies to self-attention-based models. As a result, it becomes more difficult for known object segmentation models to be trained or to perform prediction while appropriately reflecting dynamic characteristics of videos, thereby degrading the accuracy of object segmentation and tracking.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In order to solve the above-described problems, an apparatus for segmentation of an object in visual media and a method for segmentation of an object in visual media are provided.

An apparatus for segmentation of object in visual media according to an embodiment of the present disclosure may comprise a storage configured to store at least one of a query memory layer, a key memory layer, and a value memory layer and a processor configured to obtain a value feature by encoding a segmentation target visual media and a mask, generate at least one parent group based on the value feature, apply the query memory layer to the at least one parent group, apply the key memory layer to a concatenation result of the at least one parent group to which the query memory layer is applied, obtain an attention map from an application result of the key memory layer, apply the value memory layer to the attention map, and obtain a refined feature by combining an application result of the value memory layer and the value feature.

According to an embodiment, the processor may be further configured to generate at least one child group for each of the at least one parent group, and apply the query memory layer to each of the at least one child group.

According to an embodiment, the processor may be further configured to apply an application result of the key memory layer to an activation function, and obtain the attention map by normalizing the application result of the activation function.

According to an embodiment, the processor may normalize the application result of the activation function by using double normalization.

According to an embodiment, the processor may be further configured to obtain a key feature corresponding to the segmentation target visual media by performing encoding on the segmentation target visual media, and obtain a feature set by performing feature fusion using the refined feature and the key feature.

According to an embodiment, the processor may be further configured to store the refined feature and the key feature of a previous frame belonging to the segmentation target visual media in the storage, obtain the refined feature and the key feature of a current frame belonging to the segmentation target visual media, and calculate a similarity between the refined feature and the key feature of the previous frame and the refined feature and the key feature of the current frame.

According to an embodiment, the processor may be further configured to combine the feature set and the similarity and input a combined result of the feature set and the similarity to a decoder configured to output a segmentation result.

A method for segmentation of object in visual media according to an embodiment of the present disclosure may comprise encoding segmentation target visual media and a mask to obtain a value feature, generating at least one parent group based on the value feature, applying a query memory layer to the at least one parent group, applying a key memory layer to a concatenation result of the at least one parent group to which the query memory layer is applied, obtaining an attention map from an application result of the key memory layer, applying a value memory layer to the attention map and obtaining a refined feature by combining the attention map to which the value memory layer is applied and the value feature.

According to an embodiment, the method for segmentation of object in visual media may further comprise generating at least one child group for each of the at least one parent group, such that the query memory layer is applied to the at least one child group.

According to an embodiment, obtaining the attention map from the application result of the key memory layer may comprise applying the application result of the key memory layer to an activation function and obtaining the attention map by normalizing the application result of the activation function.

According to an embodiment, applying the application result of the key memory layer to an activation function may comprise normalizing the application result of the activation function by using double normalization.

According to an embodiment, the method for segmentation of object in visual media may further comprise obtaining a key feature corresponding to the segmentation target visual media by performing encoding the segmentation target visual media and obtaining a feature set by performing feature fusion using the refined feature and the key feature.

According to an embodiment, the method for segmentation of object in visual media may further comprise storing the refined feature and the key feature of a previous frame belonging to the segmentation target visual media in the storage, obtaining the refined feature and the key feature of a current frame belonging to the segmentation target visual media and calculating a similarity between the refined feature and the key feature of the previous frame and the refined feature and the key feature of the current frame.

the method for segmentation of object in visual media may further comprise combining the feature set and the similarity and inputting a combined result of the feature set and the similarity to a decoder configured to output a segmentation result.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram of apparatus for segmentation of object in visual media according to an embodiment.

FIG. 2 is a block diagram of a temporal reordering unit according to an embodiment.

FIG. 3 is a diagram for describing two-stage grouping of a temporal reordering unit according to an embodiment.

FIG. 4 is a diagram illustrating a query memory layer, a key memory layer, and a value memory layer used by a temporal reordering unit according to an embodiment.

FIG. 5 is a flowchart of an object segmentation method in visual media according to an embodiment.

FIG. 6 is a flowchart of a process of obtaining refined feature, according to an embodiment.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The advantages and features of the present invention, as well as methods for achieving them, will become apparent by referring to the embodiments described below in conjunction with the accompanying drawings. However, the present invention is not limited to the embodiments disclosed herein and may be implemented in various different forms. The embodiments are provided merely to ensure a complete disclosure of the invention and to fully convey the scope of the invention to those skilled in the art. The present invention shall be defined solely by the scope of the claims.

Hereinafter, terms used in the present specification will be briefly described, and the present disclosure will be described in detail. Although terms used in the present disclosure are selected as general terms currently widely used in the art in consideration of functions in the present disclosure, the terms may vary according to the intention of those of ordinary skill in the art, precedents, or emergence of new technologies. In addition, in specific cases, terms may be arbitrarily selected by the applicant, and in this case, the meaning of the terms will be described in detail in the corresponding description. Accordingly, the terms used in the present disclosure should be defined based on the meanings of the terms and the overall contents of the present disclosure, rather than simple names of the terms.

Throughout the specification, when a part is referred to as being “connected” to another part, it may mean that the part and the other part are physically connected to each other and/or electrically connected to each other. In addition, when a part is referred to as “including” or “comprising” another part, it does not exclude other parts unless otherwise stated, but means that it may further include other parts depending on embodiments.

Terms such as “unit”, “module”, and the like used in the specification refer to units corresponding to all or part of at least one device, system, method, structure, and material, and may process a predetermined function or operation depending on the situation. The “unit”, “module”, and the like may be implemented as software, hardware such as a Field Programmable Gate Array (FPGA) or an Application Specific Integrated Circuit (ASIC), or a combination of software and hardware, depending on designers, administrators, or users. However, the “unit”, “module”, and the like are not limited to only software or hardware. The “unit”, “module”, and the like may be configured to reside in an addressable storage medium or configured to execute on one or more processors.

Accordingly, as an example, terms such as “unit”, “module”, and the like may include components such as software components, object-oriented software components, class components, and task components, and processes, functions, attributes, procedures, subroutines, segments of program code, drivers, firmware, microcode, circuitry, data, databases, data structures, tables, arrays, and variables. According to an embodiment, one “unit”, “module”, or the like may be implemented as a single physical or logical configuration, or may be implemented as a plurality of physical or logical configurations. In addition, a plurality of “units”, “modules”, and the like may be implemented as a single physical or logical configuration.

Expressions such as first to N-th (where N is a natural number of 1 or more) are used to distinguish at least one part(s) from other part(s) for convenience of description, and may be arbitrarily selected and added to components. For example, a component named as a first component may be differently named as a second component, and a component named as a second component may also be differently named as a first component. In addition, expressions such as first to N-th do not necessarily mean that these components are sequential unless otherwise stated.

The term “and/or” may include a combination of a plurality of related items or any one of a plurality of related items, but does not exclude a combination of two or more of the plurality of related items. Singular expressions may include plural expressions unless the context clearly indicates otherwise. In addition, generally, an underscore (_) indicates that a character added after the underscore is a subscript of a character located before the underscore, and a caret (\hat{ }) indicates that a character added after the caret is a superscript of a character located before the caret, but they may be used in different meanings depending on situations.

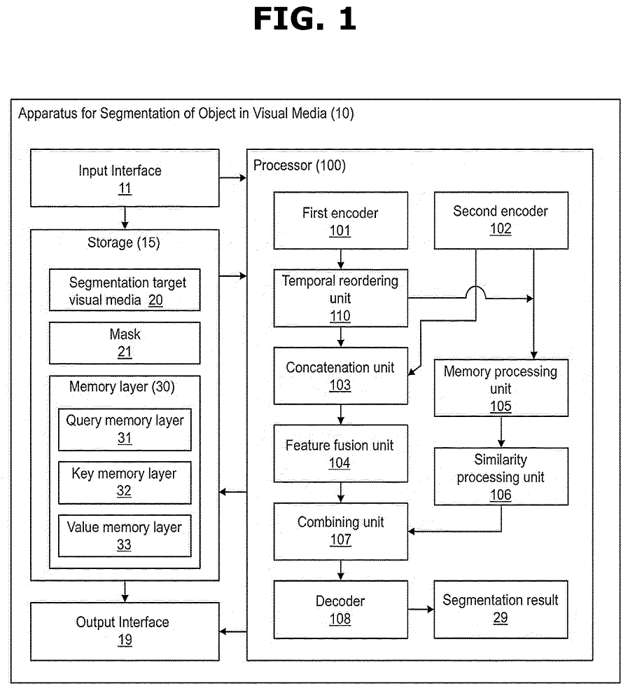

Hereinafter, an embodiment of apparatus for segmentation of object in visual media will be described with reference to FIGS. 1 to 4.

FIG. 1 is a block diagram of apparatus for segmentation of object in visual media according to an embodiment.

Referring to FIG. 1, apparatus for segmentation of object in visual media 10 (hereinafter, referred to as an object segmentation apparatus) may include an input interface 11, a storage 15, an output interface 19, and a processor 100. At least one of these is provided to be able to transmit all or part of data, commands (instructions), or programs in at least one way through a circuit line, a cable, a wireless communication network, or the like. If necessary, at least one of the input interface 11, the storage 15, and the output interface 19 may be omitted.

The input interface 11 may receive at least one data, command, program, or the like necessary for the operation of the object segmentation apparatus 10, and provide the received data, command, program, or the like to the storage 15 or the processor 100. For example, the input interface 11 may receive visual media to be segmented 20 (hereinafter, referred to as a segmentation target visual media). Here, the segmentation target visual media 20 may include at least one still image (i.e., an image frame) connected in a temporal order. These image frames may form a moving image by sequential combination. According to an embodiment, the segmentation target visual media 20 may be a still image. The input interface 11 may include, for example, a keyboard, a mouse, a tablet, a touch screen, a touch pad, a scanner device, an image capturing module, a motion sensor, a light receiving sensor, a pressure sensor, a proximity sensor, a microphone, a data input/output terminal, or a communication module (e.g., a LAN card, a short-range communication module, or a mobile communication module), but is not limited thereto.

The storage 15 may temporarily or non-temporarily store at least one data for the operation of the object segmentation apparatus 10. The storage 15 may include a register, a cache memory, a main memory device, or an auxiliary memory device according to an embodiment. These may be implemented using, for example, a semiconductor device.

According to an embodiment, the storage 15 may store the segmentation target visual media 20 input through the input interface 11 and a mask 21 related to the segmentation target visual media 20. The segmentation target visual media 20 may include, for example, an image frame of a current view, a previous view, and/or a subsequent view. The mask 21 may be divided and extracted from the segmentation target visual media 20, or may be data corresponding to at least one object extracted or to be extracted. For example, the mask 21 may be formed of data about an edge of an object or a space occupied by the object in an image. The mask 21 may be used as, for example, a label for the segmentation target visual media 20.

In addition, the storage 15 may store one or more types of memory layers 30 for processing of the processor 100, for example, at least one of the query memory layer 31, the key memory layer 32, and the value memory layer 33. Here, at least one of the query memory layer 31, the key memory layer 32, and the value memory layer 33 may be a linear layer, and may be provided to effectively store and retain information existing across all or some image frames belonging to the segmentation target visual media 20. The at least one layer 31, 32, and 33 may be learnable. The at least one layer 31, 32, and 33 is stored in a predetermined memory space of the storage 15 by reflecting a feature of at least one previously extracted image frame, and the layer 31, 32, and 33 stored in the memory space may be called to be applied to a new feature.

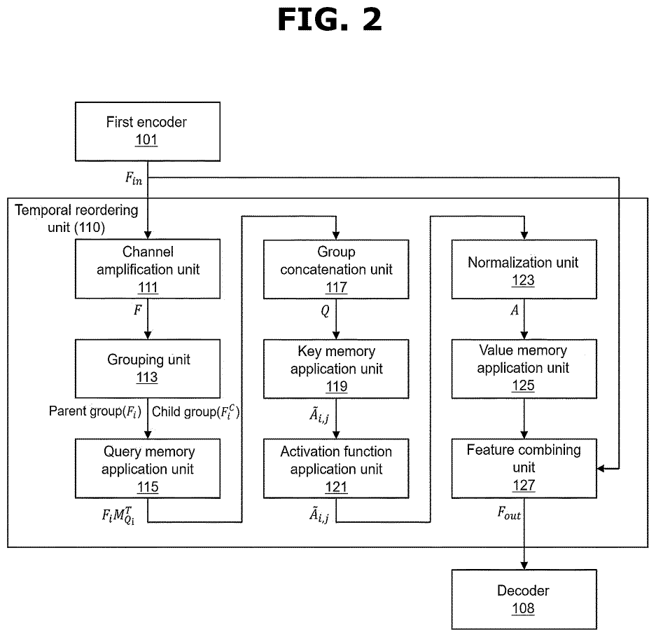

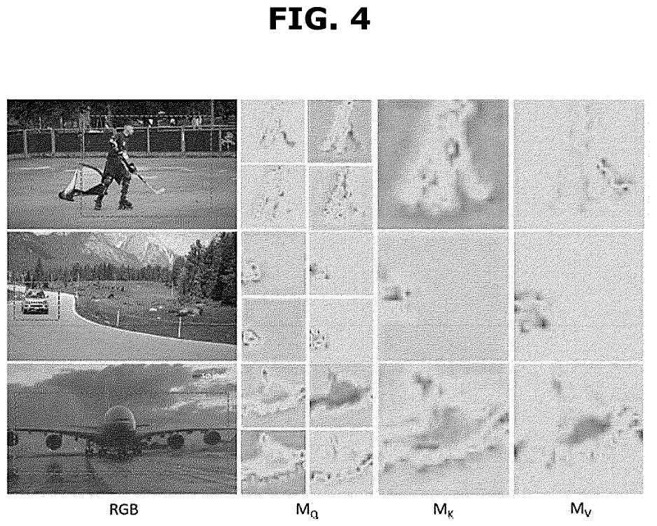

In addition, the storage 15 may store information on at least one parent group (F_i of FIGS. 2 and 4) and at least one child group (F\hat{ }C_i of FIGS. 2 and 4) corresponding to each parent group (F_i). The storage 15 may store value feature (F_in of FIG. 2), key feature, or refined feature (F_out of FIG. 2) obtained in the process of the processor 100, and/or may store at least one segmentation result 29 obtained according to the processing result. Here, the segmentation result 29 may include, for example, a set(s) of data (e.g., pixels, etc.) on the segmented and identified object, data on an edge of the corresponding object, or a portion of an image corresponding to the corresponding object.

In addition, the storage 15 may be provided to store a program executed by the processor 100. The program stored in the storage 15 may be directly written by a designer such as a programmer or the like, received from another physical recording medium (external memory device or the like), or obtained through an electronic software distribution network accessible through a wired/wireless communication network.

The output interface 19 may output data stored in the storage 15, data generated during the processing process of the processor 100, and/or a processing result of the processor, for example, the segmentation result 29, to the outside. In this case, the output interface 19 may transmit the same to another external device (not shown) (e.g., a smart phone, an image editing device, a desktop computer, or a hardware device for a server) through a wired/wireless communication network or the like, or may provide the same to the user visually or audibly. In addition, the output interface 19 may be provided to output a graphic user interface for providing visual information or inputting a command to the outside. The output interface 19 may include, but is not limited to, a display, a printer device, a speaker device, an image output terminal, a data input/output terminal, or a communication module.

The processor 100 may divide at least one object from the given segmentation target visual media 20 and obtain a segmentation result 29 for the object. In this case, the processor 100 may perform the above-described object segmentation operation by executing the program stored in the storage 15 to perform a predetermined operation, determination, processing, and/or control operation. The processor 100 may be implemented by using one or two or more processing devices alone or in combination. Here, the processing device may include, for example, a Central Processing Unit (CPU), a Graphic Processing Unit (GPU), a Micro Controller Unit (MCU), an Application Processor (AP), an Electronic Controlling Unit (ECU), or at least one electronic device capable of performing various operations and control processing. These devices may be implemented by using one or two or more semiconductor chips, circuits, or related components alone or in combination.

In an embodiment, the processor 100 may include a first encoder 101, a second encoder 102, a concatenation unit 103, a feature fusion unit 104, a memory processing unit 105, a similarity processing unit 106, a combining unit 107, a decoder 108, and a temporal reordering unit 110. Here, at least two of these may be provided to transmit data or commands/instructions to one side or to both sides. According to an embodiment, at least two of these may be logically separated, and/or may be physically separated. When logically divided, at least two of them may be implemented using one processing device (e.g., one central processing unit (CPU)). In addition, when physically separated, at least two of them may be implemented using the same processing device (e.g., two or more central processing units) or different processing devices (e.g., one or more central processing units and one or more graphic processing units).

In addition, at least one of the first encoder 101, the second encoder 102, the concatenation unit 103, the feature fusion unit 104, the memory processing unit 105, the similarity processing unit 106, the combining unit 107, the decoder 108, and the temporal reordering unit 110 may be used to train the learning model, and/or may be used to obtain a prediction result based on the learning model. Here, the learning model-based prediction result may include a result of separating/dividing at least one object from the segmentation target visual media 20 (i.e., the segmentation result 29), and training of the learning model may be performed at least once to obtain the prediction result.

The first encoder 101 may receive the segmentation target visual media 20 and the mask 21 for the segmentation target visual media 20 together to extract comprehensive or detailed feature of an object to be segmented with respect to the segmentation target visual media 20, and may obtain a predetermined feature (F_in∈R\hat{ }N×C, e.g., a feature map) corresponding to the segmentation target visual media 20 and the mask 21 by performing encoding based thereon. Here, the feature (F_in) may be a value feature. That is, the first encoder 101 may be a value encoder. The value feature (F_in) may be given in a vector format. Here, the segmentation target visual media 20 may include at least one frame of a video. That is, the value feature (F_in) may correspond to each image frame. According to an embodiment, the first encoder 101 may perform encoding using a two-dimensional convolutional neural network (2D CNN, e.g., ResNet), but is not limited thereto. The value feature (F_in) obtained by the first encoder 101 may be transmitted to the temporal reordering unit 110. The temporal reordering unit 110 will be described later.

The second encoder 102 may obtain at least one segmentation target visual media 20 and perform encoding on the at least one segmentation target visual media 20 to obtain key feature corresponding to the segmentation target visual media 20. In other words, the second encoder 102 may be a key encoder. The key feature may also be output in a vector format. The second encoder 102 may construct a relationship between the at least one segmentation target visual media 20 (e.g., a relationship between a plurality of image frames in a video). That is, the second encoder 102 is provided to reflect short-term temporal continuity between consecutive image frames. The second encoder 102 may not receive the mask 21, and accordingly, the second encoder 102 may construct a predetermined feature map regardless of the mask. In this regard, the memory processing unit 105 records the visual media 20 for the query, for example, at least one query image frame, in a predetermined memory space, so that the corresponding query image frame may be used in other image frames subsequent to the query image frame. Here, the predetermined memory space is a space provided in the storage 15 to record information on the visual media 20 for a query, and may be a physical space or a virtual space. The information on the visual media 20 for the query may include, for example, a feature of each image frame for the query or a mask related thereto among a plurality of image frames. The output key feature may be transmitted to at least one of the concatenation unit 103 and the memory processing unit 105.

The concatenation unit 103 may receive the refined feature (F_out) output from the temporal reordering unit 110 and the key feature output from the second encoder 102, and derive and obtain a concatenation result of the refined feature (F_out) and the key feature, for example, an integrated feature set, by concatenating the refined feature (F_out) and the key feature. Here, the mutually concatenated refined feature (F_out) and key feature may include a refined feature (F_out) and a key feature corresponding to the same image frame. The concatenation result of the refined feature (F_out) and the key feature is transmitted to the feature fusion unit 104.

The feature fusion unit 104 may fuse and integrate various features based on the refined feature (F_out) and the concatenation result of the key feature, and finally, necessary information, for example, a richer feature set (e.g., a feature map) may be generated. This enhanced feature set is reflected in the similarity calculation, so that the regional or temporal relationship between other portions in the visual media 20 may be better understood. The result derived from the feature fusion unit 104 may be transmitted to the combining unit 107.

The memory processing unit 105 may receive the refined feature (F_out) output from the temporal reordering unit 110 and the key feature transmitted from the second encoder 102, and record them in the storage 15. In this case, a predetermined area (memory space) may be allocated to the storage 15 to store the refined feature (F_out) and the key feature, and the storage of the refined feature (F_out) and the key feature may be stored in the corresponding area. According to an embodiment, the refined feature (F_out) and the key feature may be stored for each image frame in the corresponding area.

The similarity processing unit 106 may compare the image frame currently being processed with the image frame previously processed (i.e., the image frame stored in the storage 15), and determine how similar they are to each other. For example, the similarity processing unit 106 may call the refined feature (F_out) and the key feature (i.e., information on a pre-processed image frame) stored in the memory processing unit 105, and compare the refined feature (F_out) and the key feature stored in the called memory processing unit 105 with the key feature corresponding to the currently input image frame (i.e., information on an image frame to be currently processed) to determine the similarity therebetween. Here, the similarity may be implemented using a commonly known similarity calculation method, and may be given in the form of a matrix as necessary.

The combining unit 107 may receive an output result (e.g., a similarity matrix) of the similarity processing unit 106 and an output result (e.g., a feature set) of the feature fusion unit 104, combine them, and output a combining result corresponding to the combination result. The combining result may be transmitted to the decoder 108. The combining unit 107 may couple them through, for example, a product between the output result of the similarity processing unit 106 and the output result of the feature fusion unit 104.

The decoder 108 may receive the output result of the combining unit 107 and decode the output result of the combining unit 107. The output of the decoder 108 may include a segmentation result 29 (e.g., a predicted mask). Therefore, in the prediction process, the decoder 108 outputs data on at least one object identified and extracted from the segmentation target visual media 20.

Hereinafter, the temporal reordering unit 110 will be described.

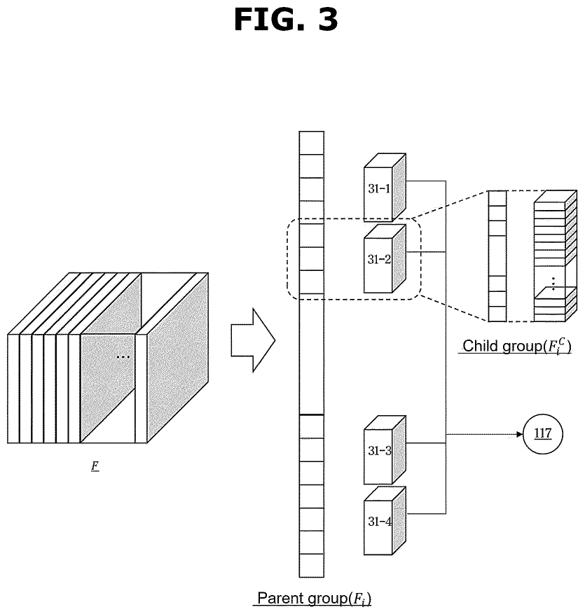

FIG. 2 is a block diagram of a temporal reordering unit according to an embodiment, and FIG. 3 is a diagram for describing two-stage grouping of a temporal reordering unit according to an embodiment.

Referring to FIG. 2, the temporal reordering unit 110 according to an embodiment may include a channel amplification unit 111, a grouping unit 113, a query memory application unit 115, a group concatenation unit 117, a key memory application unit 119, an activation function application unit 121, a normalization unit 123, a value memory application unit 125, and a feature combining unit 127. In this case, according to an embodiment, at least one of the channel amplification unit 111, the grouping unit 113, the query memory application unit 115, the group concatenation unit 117, the key memory application unit 119, the activation function application unit 121, the normalization unit 123, the value memory application unit 125, and the feature combining unit 127 may be omitted.

The channel amplification unit 111 may receive a feature (F_in), for example, a value feature, from the first encoder 101, and may obtain amplified features (F∈R\hat{ }N×C′, C′ is a dimension of an expanded channel) by expanding and amplifying the received feature (F_in).

Referring to FIG. 3, the grouping unit 113 may group an amplified feature (F) by dividing the amplified feature (F) into at least one parent group (F_i, where i is a natural number of 1 or more), and may further group each of the at least one parent group (F_i) by dividing the parent group (F_i) into at least one child group (F\hat{ }c_i, where c is a natural number of 1 or more) belonging to the corresponding parent group (F_i). The number of parent groups (F_i) may be |P| (where |P| is a natural number of 1 or more), and may be determined according to the number of independent query memory layers (31: 31-1 to 31-4). That is, the parent groups (F_i) may be given as F₁, F₂, . . . , F_|P|. Here, depending on an embodiment, the number |P| of parent groups (F_i) may be equal to or less than the number of query memory layers (31: 31-1 to 31-4) to be applied. In this case, when all parent groups are combined, the amplified feature (F) described above may be derived (F=F₁, F₂, . . . , F_|P|). In addition, the number of child groups (F\hat{ }c_i) corresponding to each parent group (F_i) may be given as |C| where |C| is a natural number of 1 or more). That is, the child groups (F\hat{ }c_i) belonging to a given parent group (F_i) may be given as F\hat{ }1_i, F\hat{ }2_i, . . . , F\hat{ }|C|_i. Here, the number of child groups (F\hat{ }c_i) corresponding to each parent group (F_i) may be the same for all parent groups (F_i), may be the same for some parent groups (F_i) and different for other parent groups (F_i), or may be different for all parent groups (F_i).

The query memory application unit 115 may obtain at least one query memory layer 31 from the storage 15 and apply the query memory layers (31: 31-1 to 31-4) to the parent group (F_i) and/or the child group (F\hat{ }c_i).

According to an embodiment, the query memory application unit 115 may apply corresponding query memory layers (31-1 to 31-4) to respective parent groups (F_i). Here, at least two of the query memory layers (31-1 to 31-4) corresponding to the respective parent groups (F_i) may be identical to each other or may be different from each other. The query memory application unit 115 may individually and independently apply the corresponding query memory layers (31-1 to 31-4) to the respective parent groups (F_i), thereby generating queries corresponding to the respective parent groups (F_i). This enables training of the feature (F) from various perspectives by independently training each parent group (F_i) so as not to share features with other parent groups (F_i). Here, applying the query memory layers (31-1 to 31-4) to the parent groups (F_i) may be expressed by Mathematical Equation 1 below.

$${F}_{i} {M}_{{Q}_{i}}^{T} \qquad [ Equation 1 ]$$

In Equation 1, M_Q_i is a query memory layer corresponding to the i-th parent group F_i. T means transpose.

In addition, according to an embodiment, the query memory application unit 115 may apply, to at least one child group (F\hat{ }c_i), a query memory layer 31 (M_Q_i) of a parent group (F_i) to which the child group (F\hat{ }c_i) belongs. In other words, the same query memory layer 31 (M_Q_i) is applied to each child group (F\hat{ }c_i) belonging to the same parent group (F_i), and accordingly, the child groups (F\hat{ }c_i) share the query memory layer 31 (M_Q_i) of the parent group (F_i). Therefore, the child groups (F\hat{ }c_i) within the same parent group (F_i) may share parameters, thereby enabling more fine-grained refinement of features.

An application result of the query memory layer 31 applied to each parent group (F_i) may be transmitted to the group concatenation unit 117. In addition, an application result of the query memory layer 31 applied to each child group (F\hat{ }c_i) may also be transmitted together to the group concatenation unit 117.

The group concatenation unit 117 may concatenate application results of the query memory layer 31 applied to the respective parent groups (F_i), thereby obtaining a concatenation result of at least one parent group (F_i) to which the query memory layer 31 is applied. Here, the concatenation result may be a query matrix. The operation of the group concatenation unit 117 may be expressed by Mathematical Equation 2 below.

$$Q = Concat ( {F}_{1} {M}_{Q 1}^{T} , {F}_{2} {M}_{Q 2}^{T} , … , {F}_{\vert P \vert} {M}_{Q \vert P \vert}^{T} ) \qquad [ Equation 2 ]$$

In Equation 2, Q means a query matrix according to a connection. The concatenation result may be transmitted to the key memory application unit 119.

The key memory application unit 119 may receive a concatenation result, for example, a query matrix (Q) from the group concatenation unit 117, obtain at least one key memory layer 32 from the storage 15, and then apply at least one learnable key memory 32 to the query matrix (Q). The application result of the key memory application unit 119 may be expressed as Equation 3 below.

$${\tilde{A}}_{i , j} = {QM}_{k}^{T} \qquad [ Equation 3 ]$$

For example, the key memory application unit 119 may obtain the application result (~A_ij) of the key memory application unit 119 by multiplying the query matrix (Q) and the key memory layers 32 (M_k).

The application result (~A_ij) of the key memory application unit 119 may be transmitted to the activation function application unit 121.

The activation function application unit 121 may obtain an activation function application result by applying the application result (~A_ij) of the key memory application unit 119 to a predetermined activation function. Here, the activation function may include, for example, a softmax function, but is not limited thereto. The application result of the activation function application unit 121 may be expressed by Equation 4 below.

$${\hat{A}}_{i , j} = \frac{exp ( {\overline{A}}_{i , j} )}{{\sum }_{k} exp {\tilde{A}}_{k , j}} \qquad [ Equation 4 ]$$

For example, when the softmax function is used, the application result (\hat{ }A_i,j) of the activation function application unit 121 may be obtained by dividing the operation result of the exponential function for the application result (~A_ij) of the key memory application unit 119 by the sum of the operation results of the exponential function of the application result (~A_ij) for all possible k.

The result of applying the activation function (\hat{ }A_i,j) may be transmitted to the normalization unit 123.

The normalization unit 123 may perform normalization based on the result of applying the activation function (\hat{ }A_i,j). According to an embodiment, the normalization unit 123 may perform normalization on the application result (\hat{ }A_i,j) of the activation function by using double normalization. Double normalization means that two dimensions (e.g., columns and rows of a matrix) are each individually normalized. This is to solve the lack of scale invariance, such as cosine similarity, because the attention map is derived from the matrix product. The double normalization may be performed by performing normalization in one of a row direction and a column direction, and then sequentially performing normalization in the other of the row direction and the column direction. In this case, the normalization of any one of the row direction and the column direction may be performed based on, for example, Equation 5 below.

$${A}_{i , j} = \frac{{\hat{A}}_{i , j}}{{\sum }_{k} {\hat{A}}_{i , k}} \qquad [ Equation 5 ]$$

As described in Equation 6, the normalization for the row (i) or the column (j) may be performed by dividing the application result (\hat{ }A_i,j) of the activation function corresponding to the row (i) or the column (j) by the sum of the application results (\hat{ }A_ij) of the activation function corresponding to the row (i) or the column (j).

The normalization result (A_ij) forms at least one attention map (A). That is, the attention map (A) is obtained according to the operation processing of the key memory application unit 119, the activation function application unit 121, and the normalization unit 123. Here, the attention map (A) may capture the relationship between the i-th pixel of the feature map (F) and the j-th row of the learnable linear layer, for example, the key memory layers 32 (M_k). Accordingly, the acquired attention map (A) may be a memory-oriented attention map. The features refined by the query memory 31 of each parent group (F_i) show a difference in the way the features are recognized. By unifying these refined features through the key memory application unit 119, the activation function application unit 121, and the normalization unit 123, more detailed and accurate information may be transmitted when generating an attention map. This makes it possible to improve the overall quality and depth of information input as a subsequent step of the model.

The normalized result, that is, the attention map (A), may be transmitted to the value memory application unit 125.

The value memory application unit 125 may apply the value memory layer 33 to the attention map (A). In this case, the output of the value memory application unit 125 may be given by Equation 6 below.

$${AM}_{V} \qquad [ Equation 6 ]$$

That is, the value memory application unit 125 may obtain the application result of the value memory layer 33 by multiplying the attention map by the value memory layer 33 (M_V).

The feature combining unit 127 may receive a feature, for example, a value feature (F_in), from the first encoder 101, and may obtain a refined feature (F_out) by combining an attention map (AM_V) to which the value memory layer 33 is applied and the value feature (F_in). For example, the feature combining unit 127 may obtain the refined feature (F_out) for the feature (F_in) by directly adding the attention map (AM_V) to which the value memory layer 33 is applied and the value feature (F_in), or by performing a weighted summation using predetermined weights. This may be given as Mathematical Equation 7 below.

$${F}_{out} = {F}_{in} + {AM}_{V} \qquad [ Equation 7 ]$$

The refined feature (F_out) may be transmitted, for example, to the decoder 108. As described above, the refined feature (F_out) may be transmitted to the decoder 108 after passing through the concatenation unit 103 and the feature fusion unit 104 and/or passing through the memory processing unit 105 and the similarity processing unit 106 and then being input to the combining unit 107. Accordingly, a segmentation result 29 is obtained.

FIG. 4 is a diagram illustrating a query memory layer, a key memory layer, and a value memory layer used by a temporal reordering unit according to an embodiment. From left to right, FIG. 4 illustrates an original visual media frame (RGB visual media frame) 20, a visualization result (M_Q) of the query memory layer 31 applied to a parent group (F_i) obtained through grouping and a child group (F\hat{ }c_i) belonging thereto, a visualization result (M_K) of the key memory layer, and a visualization result (M_V) of the value memory layer.

Referring to FIG. 4, it is possible to know a change in features learned from various perspectives through various query memory layers (31:31-1 to 31-4). Specifically, in the uppermost video frame, learning information about a hockey player, a hockey stick, a hockey puck, and a background is shown, in the intermediate video frame, learning information about a vehicle and a background is shown, and in the lowermost video frame, learning information about a plane is shown. Accordingly, it can be seen that the initial features are refined to learn various patterns, and specific information is transmitted through the process of generating an attention map using the key memory layer (M_K) and the value memory layer (M_V). In addition, it can be seen that the key linear layer (M_K) collectively shares parameters, thereby enhancing the advantages obtained by passing through several query memory layers.

The above-described object segmentation apparatus 10 may be used to train a model for object segmentation, and/or may be used to obtain an object segmentation result 29 corresponding to the segmentation target visual media 20 by using the trained model.

The object segmentation apparatus 10 may be implemented by using a specially designed apparatus to process all or some of the above-mentioned operations or controls, or may be implemented by using one or two or more information processing apparatus alone or in combination. Here, the one or more information processing devices include, for example, a server hardware device, a desktop computer, a laptop computer, a smart phone, a tablet PC, a smart watch, a smart tag, a smart band, a HMD (Head Mounted Display) device, a portable game console, a navigation device, an image capturing device (including a video capturing device such as a camcorder or an action cam), a scanner device, a remote control device (remote control), a digital television, a set top box, a digital media player device, a media streaming device, an audio playback device (artificial intelligence speaker, etc.), a home appliance (e.g., a refrigerator, a fan, an air conditioner, or a washing machine), a manned or unmanned vehicle (e.g., a vehicle, a mobile robot, a wireless model vehicle, or a robot), a medical device (e.g., an X-ray imaging device, a Magnetic Resonance Imaging apparatus, a computed tomography (CT) system, a positron emission tomography (PET) system, or a mammography device may be included, and a home/industrial/military robot or a home/industrial/military machine may be included, but is not limited thereto. A designer, a user, or the like may employ at least one of various devices for processing and controlling information in addition to the above-described information processing device according to a situation or condition by considering it as the above-described device.

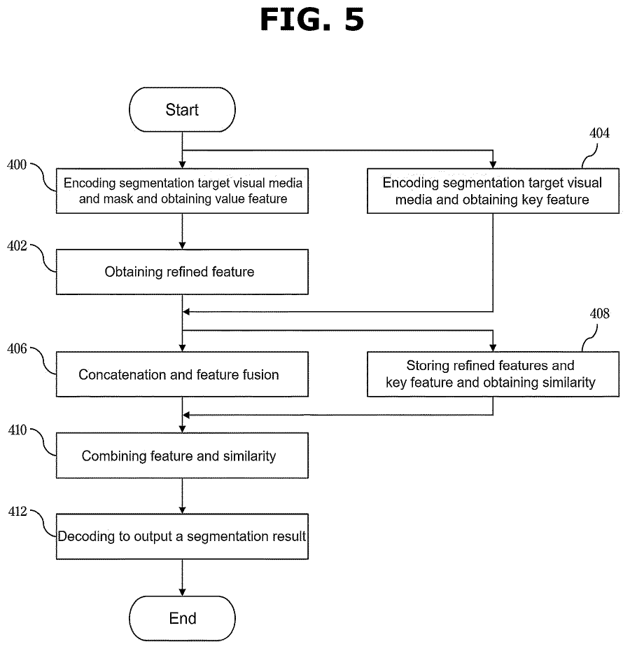

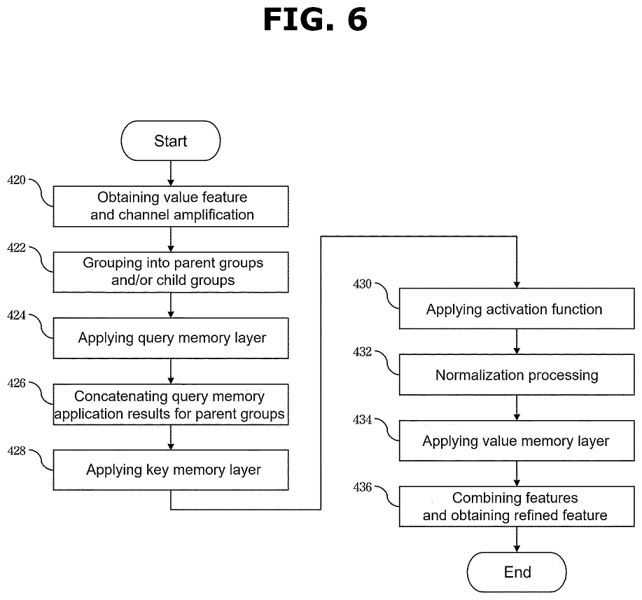

Hereinafter, an embodiment of a method of for segmentation of object in visual media will be described with reference to FIGS. 5 and 6.

FIG. 5 is a flowchart of an object segmentation method in visual media according to an embodiment.

Referring to FIG. 5, first, encoding is performed on the segmentation target visual media and a mask for the segmentation target visual media, thereby obtaining feature corresponding to the segmentation target visual media and the mask 400. Here, the feature may be value feature, and may be represented in the form of feature maps. The value feature may be obtained for each of all or some frames belonging to the segmentation target visual media. Depending on an embodiment, encoding of the segmentation target visual media and the mask may be performed using, for example, a two-dimensional convolutional neural network.

Temporal reordering is performed based on the value feature to obtain refined feature 402. This will be described in detail later.

Meanwhile, encoding of the segmentation target visual media may be performed to obtain key feature corresponding to the segmentation target visual media 404 simultaneously with or separately from obtaining the value feature based on the segmentation target visual media and the mask 400 and obtaining the refined feature 402. Obtaining the key feature 404 may be performed independently of obtaining the value feature 400 or obtaining the refined feature 402.

The refined feature and the key feature may be concatenated 406. Here, the refined feature and the key feature that are concatenated with each other may include refined feature and key feature corresponding to the same frame. Thereafter, feature fusion is performed based on a concatenation result of the refined feature and the key feature, and accordingly, a feature set, that is, a feature map, having enriched information may be obtained.

Meanwhile, simultaneously with or separately from at least one of concatenation of the refined feature and the key feature and feature fusion thereof, the refined feature and the key feature may be stored in a predetermined memory space of the storage 408. Thereafter, the refined feature and the key feature previously stored for a previous frame may be retrieved from the memory space, and a similarity between the refined feature and the key feature of a current frame and the refined feature and the key feature previously stored for the previous frame may be calculated.

A feature set obtained through the feature fusion and the calculated similarity may be combined 410.

A combined result of the feature set and the similarity may be input to the decoder and decoded 412. Here, the decoder may output a segmentation result.

Hereinafter, a process of obtaining the refined feature 402 will be described in more detail.

FIG. 6 is a flowchart of a process of obtaining refined feature, according to an embodiment.

Referring to FIG. 6, first, a value feature is obtained, and an amplified feature having an expanded channel dimension may be obtained by amplifying the value feature 420.

The amplified feature may be divided into at least one parent group and grouped, and for each of the at least one parent group, at least one child group may be further divided and grouped 422. The number of parent groups to be divided may be set by a user or a designer, and may correspond, for example, to the number of query memory layers. Accordingly, the amplified feature may be hierarchically organized to include at least one parent group and at least one child group belonging to the parent group.

A query memory layer may be applied to each parent group 424. In this case, different query memory layers may be applied to respective parent groups, some parent groups may have the same query memory layer applied while other parent groups have different query memory layers applied, or different query memory layers may be applied to all parent groups. Depending on an embodiment, the query memory layer may be applied individually and independently to each parent group, and as a result, a query corresponding to each parent group is obtained. Meanwhile, in the above process, a query memory layer may also be applied to each child group, and for each child group, the query memory layer applied to the parent group to which the child group belongs may be applied.

Parent groups to which the query memory layer is applied may be concatenated 426.

A key memory layer is applied to the concatenated parent groups to which the query memory layer is applied 428.

An application result of the key memory layer is input to an activation function, and an application result of the activation function corresponding to the application result of the key memory layer is obtained 430.

Normalization processing may be performed on the application result of the activation function 432. In this case, the normalization processing may include, for example, double normalization. An attention map is obtained according to a result of the normalization processing. Depending on an embodiment, the normalization processing may be omitted, and in this case, the attention map may be obtained based on the application result of the activation function.

A value memory layer for the attention map may be applied 434.

The attention map to which the value memory layer is applied and the above-described value feature may be combined, thereby obtaining a refined feature 438. The refined feature may be concatenated with a key feature 406, or may be stored in a memory space of the storage and then used to obtain a similarity with another frame 408.

The method for segmentation of objects in visual media according to the embodiment may be implemented in the form of a program that may be driven by a computer device. The program may include an instruction, a library, a data file, and/or a data structure alone or in combination, and may be designed and manufactured using machine language code or high-level language code. The program may be specially designed to implement the above-described method, or may be implemented using various functions or definitions that are known and used by those skilled in the art in the field of computer software. In addition, the computer device may be implemented by including a processor or a memory that enables the function of a program to be realized, and may further include a communication device as necessary. A program for implementing the method of segmenting an object in an image may be recorded in a recording medium readable by a device such as a computer. The computer-readable recording medium may include, for example, at least one type of physical storage medium capable of temporarily or non-temporarily storing one or more programs executable in response to a call by a device such as a computer, including a semiconductor storage medium such as a ROM, a RAM, an SD card, or a flash memory (e.g., a solid state drive (SSD)), a magnetic disk storage medium such as a hard disk or a floppy disk, an optical recording medium such as a compact disk or a DVD, or a magneto-optical recording medium such as a floptical disk.

Although various embodiments of the object segmentation apparatus in visual media and the object segmentation method in the image have been described, the apparatus or the method is not limited to the above-described embodiments. Other various devices or methods that may be modified and altered based on the above-described embodiment by those of ordinary skill in the art may also be an embodiment of the object segmentation device in the image or the object segmentation method in the image. For example, even if the described method(s) are performed in a different order than that described, and/or if the described component(s) of the system, structure, apparatus, circuit, etc. are combined, connected, or coupled in a different form than that described, or replaced or substituted by another component or equivalent, etc., the described method(s) may be an embodiment of the object segmentation apparatus and/or object segmentation method in the image.

Although various embodiments of an apparatus for segmentation of an object in visual media and a method for segmentation of an object in visual media have been described above, the apparatus or the method is not limited only to the above-described embodiments. Various other apparatuses or methods that may be implemented by those of ordinary skill in the art through modifications and variations based on the above-described embodiments may also be embodiments of the apparatus for segmentation of an object in visual media or the method for segmentation of an object in visual media. For example, even if the described method(s) are performed in an order different from that described, and/or components of the described system, structure, apparatus, circuit, or the like are combined, connected, or arranged in a form different from that described, or replaced or substituted with other components or equivalents, such implementations may still fall within an embodiment of the apparatus for segmentation of an object in visual media and/or the method for segmentation of an object in visual media.

What is claimed is:

1. An apparatus for segmentation of object in visual media, the apparatus comprising:
a storage configured to store at least one of a query memory layer, a key memory layer, and a value memory layer; and
a processor configured to obtain a value feature by encoding a segmentation target visual media and a mask, generate at least one parent group based on the value feature, apply the query memory layer to the at least one parent group, apply the key memory layer to a concatenation result of the at least one parent group to which the query memory layer is applied, obtain an attention map from an application result of the key memory layer, apply the value memory layer to the attention map, and obtain a refined feature by combining an application result of the value memory layer and the value feature.

2. The apparatus for segmentation of object in visual media of claim 1,
wherein the processor is further configured to generate at least one child group for each of the at least one parent group, and apply the query memory layer to each of the at least one child group.

3. The apparatus for segmentation of object in visual media of claim 1,
wherein the processor is further configured to apply an application result of the key memory layer to an activation function, and obtain the attention map by normalizing the application result of the activation function.

4. The apparatus for segmentation of object in visual media of claim 3,
wherein the processor normalizes the application result of the activation function by using double normalization.

5. The apparatus for segmentation of object in visual media of claim 1,
wherein the processor is further configured to obtain a key feature corresponding to the segmentation target visual media by performing encoding on the segmentation target visual media, and obtain a feature set by performing feature fusion using the refined feature and the key feature.

6. The apparatus for segmentation of object in visual media of claim 5,
wherein the processor is further configured to:
store the refined feature and the key feature of a previous frame belonging to the segmentation target visual media in the storage,
obtain the refined feature and the key feature of a current frame belonging to the segmentation target visual media, and
calculate a similarity between the refined feature and the key feature of the previous frame and the refined feature and the key feature of the current frame.

7. The apparatus for segmentation of object in visual media of claim 6,
wherein the processor is further configured to:
combine the feature set and the similarity; and
input a combined result of the feature set and the similarity to a decoder configured to output a segmentation result.

8. A method for segmentation of object in visual media, the method comprising:
encoding segmentation target visual media and a mask to obtain a value feature;
generating at least one parent group based on the value feature;
applying a query memory layer to the at least one parent group;
applying a key memory layer to a concatenation result of the at least one parent group to which the query memory layer is applied;
obtaining an attention map from an application result of the key memory layer;
applying a value memory layer to the attention map; and
obtaining a refined feature by combining the attention map to which the value memory layer is applied and the value feature.

9. The method for segmentation of object in visual media of claim 8, further comprising:
generating at least one child group for each of the at least one parent group, and applying the query memory layer to each of the at least one child group.

10. The method for segmentation of object in visual media of claim 8,
wherein obtaining the attention map from the application result of the key memory layer comprising:
applying the application result of the key memory layer to an activation function; and
obtaining the attention map by normalizing the application result of the activation function.

11. The method for segmentation of object in visual media of claim 10,
wherein applying the application result of the key memory layer to an activation function comprising:
normalizing the application result of the activation function by using double normalization.

12. The method for segmentation of object in visual media of claim 8, further comprising:
obtaining a key feature corresponding to the segmentation target visual media by performing encoding the segmentation target visual media; and
obtaining a feature set by performing feature fusion using the refined feature and the key feature.

13. The method for segmentation of object in visual media of claim 12, further comprising:
storing the refined feature and the key feature of a previous frame belonging to the segmentation target visual media in the storage;
obtaining the refined feature and the key feature of a current frame belonging to the segmentation target visual media; and
calculating a similarity between the refined feature and the key feature of the previous frame and the refined feature and the key feature of the current frame.

14. The method for segmentation of object in visual media of claim 13, further comprising:
combining the feature set and the similarity; and
inputting a combined result of the feature set and the similarity to a decoder configured to output a segmentation result.
